(19) United States
(12) Patent Application Publication
(10) Pub. No.: US 2013/0080981 A1
(43) Pub. Date: Mar. 28, 2013

(54) METHOD FOR IMPROVING OPTICAL PROXIMITY SIMULATION FROM EXPOSURE RESULT

(71) Applicant: Teng-Yen Huang, Taipei City (TW)

(72) Inventor: Teng-Yen Huang, Taipei City (TW)

(21) Appl. No.: 13/239,409

(22) Filed: Sep. 22, 2011

(51) Int. Cl. G06F 17/50

(52) U.S. Cl. 716/53

(57) ABSTRACT

A method for improving an optical proximity simulation is disclosed. First, multiple exposure data are determined. An original simulation result corresponding to the exposure result and generated from multiple original simulation parameters is provided. Then, an original deviation value from the original simulation result and the exposure result is verified to determine whether it is within a predetermined range. Next, the original simulation parameters are adjusted to obtain adjusted simulation parameters. The adjusted simulation parameters whose adjusted deviation value is within the predetermined range are collected to obtain an optical proximity correction model for outputting a pattern on a reticle.

### BACKGROUND OF THE INVENTION

1. Field of the Invention

The present invention relates to a method for improving an optical proximity simulation in the light of an actual exposure result for outputting a pattern on a reticle. In particular, the present invention relates to a method for improving an optical proximity simulation in the light of an actual exposure result for outputting a pattern on a reticle by collecting adjusted simulation parameters whose deviation value is smaller than a predetermined target.

2. Description of the Prior Art

The quality of critical dimension (CD) measurement data on a wafer is one of the most important indexes when an optical proximity correction (OPC) model is being built. Currently, fitting logic and maximal algorithm are widely used for the CD measurement; however, there are some problems in recent OPC data collection for OPC model building.

Generally speaking, as much OPC data as possible are needed for a good OPC model construction, meaning a lot of time is expended to meet this requirement. Other problems are: the CD measurement variations are hard to be clarified; only Width/Length information is provided by SEM tools; and no corner information is revealed.

Currently, a method for the optimization of measurement parameters on CD SEM tools is proposed in order to obtain better quality results or alter the average by several points for minimizing measurement variations.

### SUMMARY OF THE INVENTION

The present invention proposes a method for improving an optical proximity simulation from an exposure result for outputting a pattern on a reticle. First, a plurality of exposure data is determined from exposure information of an exposure result. An original simulation result corresponding to the exposure result and generated from a plurality of original simulation parameters is provided. Then, an original deviation value obtained from the original simulation result and from the exposure result is verified to check if it is within a predetermined range. If not, the original simulation parameters are adjusted to obtain adjusted simulation parameters and an adjusted simulation result. An adjusted deviation value obtained from the adjusted simulation result and from the exposure result is verified when the original deviation value is not within the predetermined range. The adjusted simulation parameters are continuously adjusted till the adjusted deviation value is within the predetermined range. Then, the adjusted simulation parameters whose adjusted deviation value is within the predetermined range are collected to obtain an optical proximity correction model for outputting a pattern on a reticle.

In one embodiment of the present invention, the exposure information involves a curved pattern, such as a circle or an oval.

In another embodiment of the present invention, the exposure data comprises at least a first sample data, a second sample data, a third sample data and a fourth sample data.

In another embodiment of the present invention, the first sample data is one of the longest diameter and the shortest diameter of the curved pattern.

In another embodiment of the present invention, the second sample data, the third sample data and the fourth sample data respectively correspond to a dimension of a point disposed on one of the longest diameter and the shortest diameter of the curved pattern, and the point is determined by the following formula:

k/2ⁿ

wherein n is a nature number greater than 2 and k is an odd number smaller than 2ⁿ.

In another embodiment of the present invention, each of the second sample data, the third sample data and the fourth sample data is obtained from the asymmetric point.

In another embodiment of the present invention, the point is selected from 3/(2ⁿ) to (2n−3)/(2n).

In another embodiment of the present invention, the original simulation result comprises at least a first original simulation data, a second original simulation data, a third original simulation data and a fourth original simulation data which respectively correspond to the first sample data, the second sample data, the third sample data and the fourth sample data of the exposure data.

In another embodiment of the present invention, the exposure data are obtained by matching an image data of the exposure result and a digital data of the exposure result.

In another embodiment of the present invention, the original simulation parameters include one of a numerical aperture (NA), a sigma_in/out, a dsigma_in/out, an image diffusion, an apodization_loss and a def_start.

In another embodiment of the present invention, the original deviation value is a root mean square value.

In another embodiment of the present invention, adjusting the original simulation parameters may further include the following steps. First, a first parameter of the original simulation parameters is adjusted to the minimum. The adjusted deviation value is verified to check if it is within the predetermined range or smaller than the previous deviation value.

In another embodiment of the present invention, the method may further include the following steps. The first parameter is frozen when the adjusted deviation value with the minimum of the first parameter is smaller than the original deviation value.

In another embodiment of the present invention, the method may further include the following steps. The first parameter is adjusted to the maximum and verified to check if the adjusted deviation value is within the predetermined range or smaller than the previous deviation value when the adjusted deviation value with the minimum of the first parameter is not less than the previous deviation value.

In another embodiment of the present invention, the method may further include the following steps. A next parameter of the adjusted simulation parameters is adjusted to the minimum. Second, a next adjusted deviation value obtained from the adjusted simulation result, from the exposure result, from the next parameter and from the first parameter which is frozen is verified to determine whether it is within the predetermined range or smaller than the previous deviation value.

In another embodiment of the present invention, the method may further include the following steps. The next parameter is frozen when the current adjusted deviation value becomes smaller than the previous adjusted deviation value.

In another embodiment of the present invention, the method may further include the following steps. Adjusting of the first parameter is ended when the adjusted deviation value with the maximum of the first parameter is still not less than the original deviation value or the previous deviation value.

In another embodiment of the present invention, the method may further include the following steps. First, a first parameter of the original simulation parameters is adjusted to half of a first possible value. Second, the adjusted deviation value is verified to determine whether it is within the predetermined range.

In another embodiment of the present invention, the first possible value is one of a minimum value and a maximum value.

In another embodiment of the present invention, the method may further include the following steps. The first parameter is frozen when the adjusted deviation value is smaller than the original deviation value or the previous deviation value.

In another embodiment of the present invention, the method may further include the following steps. The first parameter is adjusted to half of a second possible value and verified to determine whether the adjusted deviation value is within the predetermined range when the adjusted deviation value of the first parameter is greater than the original deviation value or the previous deviation value.

In another embodiment of the present invention, the second possible value is one of a minimum value and a maximum value and the first possible value and the second possible value are different.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 illustrate methods for improving an optical proximity simulation from an exposure result of the present invention.

### DETAILED DESCRIPTION

The method of the present invention obtains an optical proximity correction model for outputting a pattern on a reticle by collecting the adjusted simulation parameters which are acceptable. These adjusted simulation parameters are obtained from the method of the present invention and have an adjusted deviation value within a predetermined range.

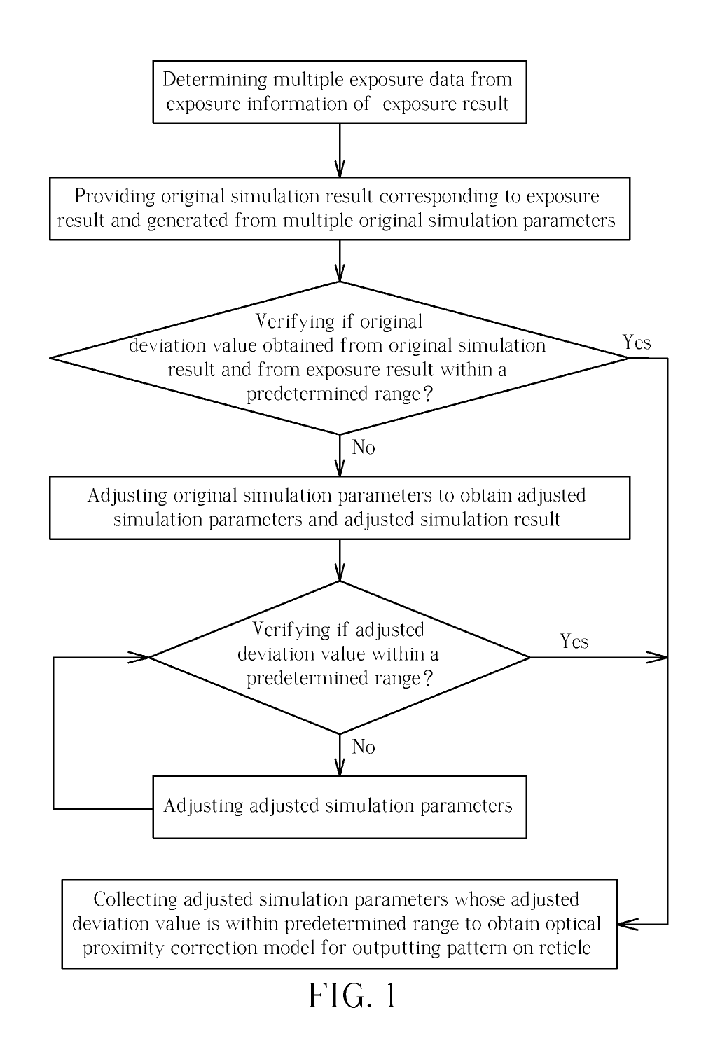

FIGS. 1—illustrate methods for improving an optical proximity simulation according to an exposure result of the present invention. FIG. 1 illustrates a flow chart of the method of the present invention. First, exposure information from an actual exposure result is provided. In order to perform a successful exposure and obtain a successful exposure result, there are various exposure data in the exposure information meaning that a plurality of exposure data from exposure information of an exposure result need to be determined. For example, the exposure data may be NA, DOE setting (annular, conventional), sigma out or sigma in.

In one embodiment of the present invention, the exposure information comes from a curved pattern. The curved pattern may be a circle, an oval or a similar shape. In another embodiment of the present invention, the exposure data includes multiple exposure data, for example at least four exposure data. For a simple example, the exposure data includes at least a first sample data, a second sample data, a third sample data and a fourth sample data. The exposure data may be obtained by matching an image data of the actual exposure result and a digital data of the exposure result. The image data may be obtained from a SEM picture. The image data may be the data obtained from the CD-SEM, and the digital data may be the data coming from SEM pictures.

For example, the pattern on a reticle comes from a digital data and is transferred to a substrate to form an image data via an exposure procedure. Theoretically speaking, the image data and the digital data should be substantially the same. Accordingly, the exposure data may be obtained by matching an image data of the actual exposure result and a digital data of the exposure result. The alignment mark of the pattern may be used as a reference to match the image data and the digital data to obtain the exposure data.

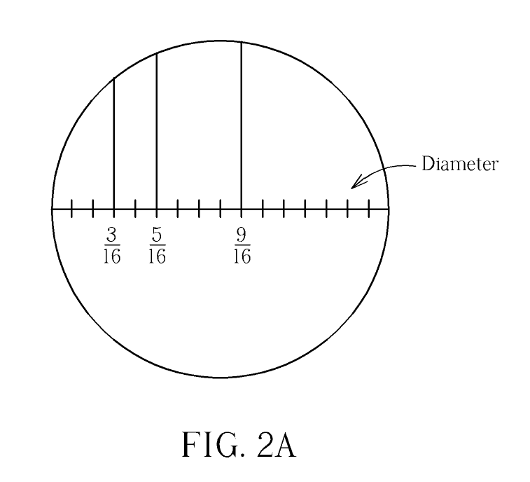

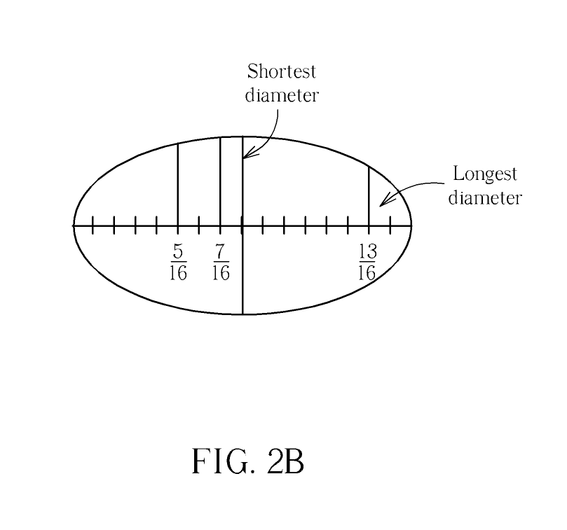

Please refer to FIGS. 2A and 2B. In the case of a curved pattern, there will either be a universal diameter in the curved pattern such as a circle in FIG. 2A, or a longest diameter and a shortest diameter in the curved pattern, such as an oval in FIG. 2B. The first sample data is preferably the diameter of a circle, or one of the longest diameter and the shortest diameter of the curved pattern.

Further, as shown in FIGS. 2A and 2B, the second sample data, the third sample data and the fourth sample data may preferably respectively correspond to a dimension of a point which is disposed on either a diameter or one of the longest diameter and the shortest diameter of the curved pattern. Also, the second sample data, the third sample data and the fourth sample data may preferably be asymmetric points obtained from the diameter. For example, the point is selected from the group defined by the following formula:

k/2ⁿ

wherein n is a nature number greater than 2 and k is an odd number smaller than 2ⁿ. When n=3, k may be 1, 3, 5 and 7. When n=4, k may be 1, 3, 5, 7, 9, 11, 13 and 15. Preferably, when n is greater than 3, the smallest k (k=1) and the largest k (k=2ⁿ−1) may be skipped. In FIG. 2A, the points 3/16, 5/16 and 9/16 are illustrated. In FIG. 2B, the points 5/16, 7/16 and 13/16 are illustrated.

An original simulation result which corresponds to the exposure result is provided. The original simulation result is a result which is obtained from an optical simulation which simulates an exposure result without using an actual lithographic device. The optical simulation may be obtained from progen model templates. The original simulation result should resemble the exposure result as much as possible.

In order to obtain a good simulation result which resembles the exposure result as much as possible, there are various simulation parameters involved with the original simulation result. Once different simulation parameters are used, the simulation result should alter accordingly as well. These simulation parameters which are directly related to the original simulation result are called original simulation parameters. There may be various different original simulation parameters, such as a numerical aperture (NA), a sigma_in/out, a dsigma_in/out, an image_diffusion, an apodization_loss, and a def_start. The goal of the present invention is to obtain optimized simulation parameters which closely resemble the actual exposure result. These simulation parameters help to construct an optical proximity correction model for outputting a pattern on a reticle.

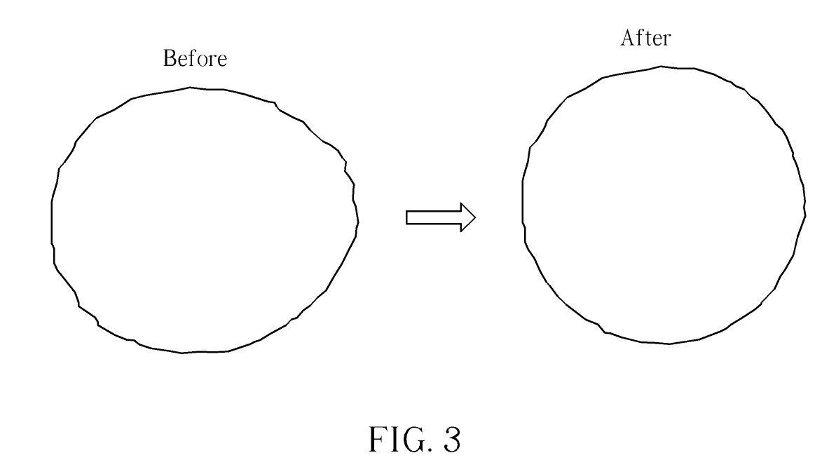

As shown in FIG. 3, the difference between the actual exposure result and the original simulation result are compared with each other. For simplicity, only scenarios of a circle are illustrated in the following example but the same principles apply to other curved patterns. Ideally, the original simulation result is the same as the actual exposure result. Since the original “simulation result” is obtained from the simulation of a group of original simulation parameters, the original simulation result may not be as close as, or may deviate slightly from the actual exposure result.

Because the original simulation parameters are the decisive variants to determine the similarity of the original simulation result to the actual exposure result, the original simulation parameters need to be adjusted and judged to determine whether the original simulation result substantially deviates from the actual exposure result or not.

The judgment of the similarity of the original simulation result to the actual exposure result is determined by a value, which is called a deviation value. The deviation value which directly corresponds to the original simulation parameters is called “an original deviation value.” Similarly, the deviation value which directly corresponds to an adjusted simulation parameter is called “an adjusted deviation value.” In other words, the original deviation value obtained from the original simulation result and from the exposure result should be verified to check whether the original deviation value is within a predetermined range or not for representing the similarity between these two results, i.e. the simulation result and the actual exposure result.

In one embodiment of the present invention, if the original deviation value is within a predetermined range, for example not greater than 2.0, these simulation parameters may be collected to obtain an optical proximity correction model for outputting a pattern on a reticle because the simulation result is considered to be similar enough to the actual exposure result. In another embodiment of the present invention, if the original deviation value is outside a predetermined range, the original simulation parameters need adjusting and substantial optimizing to obtain improved simulation parameters. This procedure will be repeated until the deviation value is within a predetermined range.

Because the simulation result corresponds to the actual exposure result, the simulation result may have the same number of simulation data as the exposure data. In one aspect, if the exposure data includes four sample data, the simulation data may also have four simulation data. In another aspect, if the exposure data includes at least four sample data or more than four sample data, the simulation data may also have at least four simulation data or more than four simulation data.

In other words, a first original simulation data (X1), a second original simulation data (X2), a third original simulation data (X3) and a fourth original simulation data (X4) respectively correspond to the first sample data (S1), the second sample data (S2), the third sample data (S3) and the fourth sample data (S4) of the exposure data. In one embodiment of the present invention, the deviation value may be a root mean square value of the simulation data and the sample data. If there is a total of n simulation data (Xi) and n sample data (Si), the deviation value may be presented by the following formula:

Deviation Value=[Σ(Si−Xi)²/n]^{1/2}

If the original deviation value coming from the original simulation parameters is not within a predetermined range, the original simulation parameters need further adjusting and substantial optimizing to obtain the improved simulation parameters. Then, a new deviation value, now called the adjusted deviation value, coming from the adjusted simulation data should be verified to determine whether the adjusted deviation value which obtained from the adjusted simulation data and from the exposure data is within the predetermined range or not. Again, the deviation value may be calculated using the above formula.

The original simulation parameters which are directly adjusted in a first stage may be called “the first adjusted simulation parameters.” The first adjusted simulation parameters are used in the simulation step to obtain an adjusted simulation result, which may be called the first adjusted simulation result. Due to different simulation parameters being used, the adjusted simulation result should differ from the original simulation result so there will be new simulation data, called adjusted simulation data. For example, if the exposure data includes four sample data, namely the first sample data, the second sample data, the third sample data and the fourth sample data, a new simulation data may also include four adjusted simulation data which respectively correspond to the first sample data, the second sample data, the third sample data and the fourth sample data of the exposure data. FIG. 3 illustrates an original simulation result (before) and an adjusted simulation result (after).

The following steps demonstrate one possible procedure to adjust the original simulation parameters. First, one parameter, namely a first parameter, is selected from the original simulation parameters. The first parameter may be a logical selection, for example a numerical aperture. Second, the first parameter of the original simulation parameters is adjusted to a minimum value. Then, an adjusted deviation value is obtained in accordance with the above-mentioned principles and verified to check if the adjusted deviation value is within the predetermined range or not.

There may be two possible results. Either the adjusted deviation value is within the predetermined range or the adjusted deviation value is not within the predetermined range. If the adjusted deviation value is within a predetermined range, for example not greater than 2.0, these adjusted simulation parameters whose adjusted deviation value is within the predetermined range may be collected to obtain an optical proximity correction model for outputting a pattern on a reticle. Alternatively, if the adjusted deviation value is not within a predetermined range, the adjusted simulation parameters may need further adjusting and substantial optimizing to obtain improved simulation parameters.

In one embodiment of the present invention, the first parameter will remain unchanged (frozen at the minimum value) in the following steps when the adjusted deviation value with the minimum value of the first parameter is smaller than the previous/original deviation value. In another embodiment of the present invention, the first parameter is adjusted to the maximum value if the adjusted deviation value with the minimum value of the first parameter is not smaller than the original deviation value. The adjusted deviation value is again verified to determine whether the adjusted deviation value is within the predetermined range or smaller than the previous (adjusted) deviation value with the minimum value when the adjusted deviation value uses the first parameter as the maximum value.

When the adjusted deviation value with the maximum value of the first parameter is smaller than the original deviation value, the first parameter will remain unchanged (frozen at the maximum value) in the following steps. If the adjusted deviation value with the maximum value of the first parameter is still not smaller than the previous (adjusted) deviation value with the minimum value, the first parameter is then not adjusted (or adjusting ends) because this may imply the first parameter is not sensitive and not dominant enough for the adjustment of the simulation data. Another parameter, called a next parameter or a second parameter, is thereby selected from the original simulation parameters and introduced for further adjustment.

In light of the above, since the adjustment of first parameter is abandoned, a next parameter, i.e. the second parameter of the adjusted simulation parameters, is adjusted in accordance with the above principles. For example, the next parameter is adjusted to the minimum or to the maximum to check if a next adjusted deviation value is within the predetermined range or smaller than the previous deviation value.

If some next parameter renders the corresponding next adjusted deviation value within the predetermined range, these adjusted simulation parameters whose adjusted deviation value is within the predetermined range may be collected to obtain an optical proximity correction model for outputting a pattern on a reticle. If some next parameter renders the corresponding next adjusted deviation value smaller than the previous deviation value, such next parameter will be similarly frozen at the current value for the following steps. The selection, adjustment and verification procedure will be repeatedly carried out until a next adjusted deviation value is within the predetermined range.

The following steps demonstrate another possible procedure to adjust the original simulation parameters. First, one parameter, namely a first parameter, is selected from the original simulation parameters. The first parameter may be a logical selection, for example a numerical aperture. Second, the first parameter from the original simulation parameters is adjusted to half of a first possible value. The first possible value may optionally be a minimum value or a maximum value. Then, the adjusted deviation value from the first parameter is verified to determine whether the adjusted deviation value is within the predetermined range or smaller than the previous deviation value in accordance with the above-mentioned principles.

There may be multiple possible results. The adjusted deviation value is within the predetermined range or the adjusted deviation value is again not within the predetermined range. If the adjusted deviation value is within a predetermined range, for example not greater than 2.0, these adjusted simulation parameters whose adjusted deviation value is within the predetermined range may be collected to obtain an optical proximity correction model for outputting a pattern on a reticle. Alternatively, if the adjusted deviation value is not within a predetermined range, the adjusted simulation parameters need further adjusting and substantial optimizing to obtain improved simulation parameters.

In one embodiment of the present invention, if the adjusted deviation value from the first parameter is smaller than the previous deviation value but is not within the predetermined range, the first parameter will remain unchanged (frozen at the value) in the following steps.

In another embodiment of the present invention, if the adjusted deviation value from the first parameter is not smaller than the previous deviation value, the first parameter of the original simulation parameters is consequently adjusted to half of the other possible value, namely a second possible value. The first possible value and the second possible value are different. Again, if the adjusted deviation value from the first parameter (half of the other possible value) is within the predetermined range, these adjusted simulation parameters whose adjusted deviation value is within the predetermined range are ready to be collected to obtain an optical proximity correction model for outputting a pattern on a reticle.

Alternatively, if the adjusted deviation value from the first parameter is smaller than the previous deviation value, the first parameter will remain unchanged (frozen at the value) in the following steps.

In another embodiment of the present invention, if the adjusted deviation value from the other possible value is not smaller than the previous deviation value, the first parameter of the original simulation parameters is not adjusted. Another parameter, called a next parameter or a second parameter, is thereby selected from the original simulation parameters and introduced for further adjustment.

In light of the above, since the adjustment of the first parameter is abandoned, a next parameter (i.e. the second parameter of the adjusted simulation parameters) is adjusted in accordance with the above principles. For example, the next parameter is adjusted to either half of a first possible value or half of a second possible value. The first possible value and the second possible value may also be a minimum value or a maximum value, and mutually different. A next adjusted deviation value is verified again to determine whether the next adjusted deviation value is within the predetermined range or smaller than the previous deviation value.

If one next parameter renders the corresponding next adjusted deviation value within the predetermined range, these adjusted simulation parameters whose adjusted deviation value is within the predetermined range may be collected to obtain an optical proximity correction model for outputting a pattern on a reticle. Alternatively, if the next adjusted deviation value is smaller than the previous deviation value but not within the predetermined range, the next parameter will be similarly frozen at the current value for the following steps. The selection, adjustment and verification procedure will be repeatedly carried out until a next parameter makes a corresponding next adjusted deviation value within the predetermined range so these adjusted simulation parameters whose adjusted deviation value is within the predetermined range may be collected to obtain an optical proximity correction model for outputting a pattern on a reticle.

The present invention uses a SEM image to get the necessary information for OPC model building. The present invention has at least the following benefits. First, no extra tool is needed. Second, the present invention can reduce the inline OPC measurement time by saving measurement tool time and model building circle time. Third, the present invention can get rid of the slimming effect as a pattern will be larger for the 2nd measurement. Fourth, the present invention reduces the CD variation from the inline measurement. Fifth, the present invention obtains good scale information and high resolution CD measurement. Sixth, the present invention gets more information for OPC model building (multi-CD value). The present invention also obtains accurate and necessary corner rounding information.

Those skilled in the art will readily observe that numerous modifications and alterations of the device and method may be made while retaining the teachings of the invention.

What is claimed is:

1. A method for improving an optical proximity simulation from an exposure result for outputting a pattern on a reticle, comprising:
determining a plurality of exposure data from exposure information of an exposure result;
providing an original simulation result corresponding to said exposure result and generated from a plurality of original simulation parameters;
verifying if an original deviation value obtained from said original simulation result and from said exposure result is within a predetermined range;
adjusting said original simulation parameters to obtain adjusted simulation parameters and an adjusted simulation result and verifying an adjusted deviation value obtained from said adjusted simulation result and from said exposure result when said original deviation value is not within said predetermined range;
adjusting said adjusted simulation parameters until said adjusted deviation value is within said predetermined range; and
collecting said adjusted simulation parameters whose said adjusted deviation value is within said predetermined range to obtain an optical proximity correction model for outputting a pattern on a reticle.

2. The method for improving an optical proximity simulation from an exposure result for outputting a pattern on a reticle of claim 1, wherein said exposure information involves a curved pattern.

3. The method for improving an optical proximity simulation from an exposure result for outputting a pattern on a reticle of claim 2, wherein said exposure data comprises at least a first sample data, a second sample data, a third sample data and a fourth sample data.

4. The method for improving an optical proximity simulation from an exposure result for outputting a pattern on a reticle of claim 3, wherein said first sample data is one of the longest diameter and the shortest diameter of said curved pattern.

5. The method for improving an optical proximity simulation from an exposure result for outputting a pattern on a reticle of claim 3, wherein said second sample data, said third sample data and said fourth sample data respectively correspond to a dimension of a point disposed on one of the longest diameter and the shortest diameter of said curved pattern, and said point is selected from the group defined by the following formula:
k/2ⁿ
wherein n is a nature number greater than 2 and k is an odd number smaller than 2ⁿ.

6. The method for improving an optical proximity simulation from an exposure result for outputting a pattern on a reticle of claim 5, wherein each of said second sample data, said third sample data and said fourth sample data is obtained from said asymmetric point.

7. The method for improving an optical proximity simulation from an exposure result for outputting a pattern on a reticle of claim 5, wherein said point is selected from the group consisting of 3/2n to 2n−3/2n.

8. The method for improving an optical proximity simulation from an exposure result for outputting a pattern on a reticle of claim 1, wherein said original simulation result comprises at least a first original simulation data, a second original simulation data, a third original simulation data and a fourth original simulation data which respectively correspond to said first sample data, said second sample data, said third sample data and said fourth sample data of said exposure data.

9. The method for improving an optical proximity simulation from an exposure result for outputting a pattern on a reticle of claim 1, wherein said exposure data is obtained by matching an image data of said exposure result and a digital data of said exposure result.

10. The method for improving an optical proximity simulation from an exposure result for outputting a pattern on a reticle of claim 1, wherein said original simulation parameters comprise a numerical aperture (NA), a sigma_in/out, a dsigma_in/out, an image diffusion, an apodization_loss, and a def_start.

11. The method for improving an optical proximity simulation from an exposure result for outputting a pattern on a reticle of claim 1, wherein said original deviation value is a root mean square value.

12. The method for improving an optical proximity simulation from an exposure result for outputting a pattern on a reticle of claim 1, wherein adjusting said original simulation parameters comprises:
adjusting a first parameter of said original simulation parameters to the minimum; and
verifying if said adjusted deviation value is within said predetermined range.

13. The method for improving an optical proximity simulation from an exposure result for outputting a pattern on a reticle of claim 12, further comprising:
freezing said first parameter when said adjusted deviation value with the minimum of said first parameter is smaller than said original deviation value.

14. The method for improving an optical proximity simulation from an exposure result for outputting a pattern on a reticle of claim 12, further comprising:
adjusting said first parameter to the maximum and verifying if said adjusted deviation value is within said predetermined range when said adjusted deviation value with the minimum of said first parameter is greater than said original deviation value.

15. The method for improving an optical proximity simulation from an exposure result for outputting a pattern on a reticle of claim 13, further comprising:
adjusting a next parameter of said adjusted simulation parameters to the minimum; and
verifying if a next adjusted deviation value obtained from said adjusted simulation result, said exposure result, said next parameter and said first parameter which is frozen is within said predetermined range.

16. The method for improving an optical proximity simulation from an exposure result for outputting a pattern on a reticle of claim 15, further comprising:
freezing said next parameter when current said adjusted deviation value becomes smaller than previous said adjusted deviation value.

17. The method for improving an optical proximity simulation from an exposure result for outputting a pattern on a reticle of claim 14, further comprising:
quitting adjusting said first parameter when said adjusted deviation value with the maximum of said first parameter is still greater than said original deviation value.

18. The method for improving an optical proximity simulation from an exposure result for outputting a pattern on a reticle of claim 1, wherein adjusting said original simulation parameters comprises:
adjusting a first parameter of said original simulation parameters to half of a first possible value; and
verifying if said adjusted deviation value is within said predetermined range.

19. The method for improving an optical proximity simulation from an exposure result for outputting a pattern on a reticle of claim 18, wherein said first possible value is one of a minimum value and a maximum value.

20. The method for improving an optical proximity simulation from an exposure result for outputting a pattern on a reticle of claim 18, further comprising:
freezing said first parameter when said adjusted deviation value is smaller than said original deviation value.

21. The method for improving an optical proximity simulation from an exposure result for outputting a pattern on a reticle of claim 18, further comprising:
adjusting said first parameter to half of a second possible value and verifying if said adjusted deviation value is within said predetermined range when said adjusted deviation value of said first parameter is greater than said original deviation value.

22. The method for improving an optical proximity simulation from an exposure result for outputting a pattern on a reticle of claim 21, wherein said second possible value is one of a minimum value and a maximum value and said first possible value and said second possible value are different.
